(19) United States
(12) Patent Application Publication
(10) Pub. No.: US 2024/0101736 A1
(43) Pub. Date: Mar. 28, 2024

(54) SONICATION OF CATALYST IN THE PRODUCTION OF AN UNSATURATED ISOOLEFIN COPOLYMER

(71) Applicant: ARLANXEO SINGAPORE PTE. LTD., Singapore (SG)

(72) Inventors: Jeremy BOURQUE, Brights Grove (CA); Gregory J. E. DAVIDSON, London (CA); Kuruppu JAYATISSA, London (CA)

(21) Appl. No.: 18/267,374

(22) PCT Filed: Dec. 14, 2021
(86) PCT No.: PCT/CA2021/051804

§ 371 Date: Jun. 14, 2023

(30) Foreign Application Priority Data
Dec. 18, 2020 (EP) 20215408.4

(51) Int. Cl. C08F 210/12

(52) U.S. Cl. CPC C08F 210/12

(57) ABSTRACT

A process for producing an unsaturated isoolefin copolymer involves: sonicating a solution of an initiator system in an organic solvent, the initiator system comprising a Lewis acid catalyst and a proton source, to produce a sonicated initiator solution, the sonicating performed at an energy input of 100 J/mL or greater, based on volume of the initiator solution; and then, contacting the sonicated initiator solution with a reaction mixture of at least one isoolefin monomer and at least one copolymerizable unsaturated monomer in an organic diluent to produce the unsaturated isoolefin copolymer. Sonication of the initiator solution improves catalyst activity, thereby improving conversion of the monomers during production of the unsaturated isoolefin copolymer.

### CROSS-REFERENCE TO RELATED APPLICATIONS

This application claim priority to European patent application EP 20215408.4 filed Dec. 18, 2020, the entire contents of which is herein incorporated by reference.

### FIELD

This application relates to the production of unsaturated isoolefin copolymers, for example butyl rubbers.

### BACKGROUND

The AlCl₃/H₂O initiating system for butyl rubber suffers from variability in the activity of the catalyst. This is attributed to differences in the ratio of active species to inactive species, as aluminum trichloride (AlCl₃) is known to form aggregates with itself and with water, which generate inactive species that do not initiate polymerization. Variability in the number of active species changes the number of initiating sites in the polymerization reactor, and if increased suddenly without reducing the catalyst addition to the reactor, can result in low molecular weight product, localized temperature increases and fouling of the reactor. Similar issues with a reactor going cold and the reaction stopping can also occur if the number of active species decreases. Reducing the variability of the catalyst activity for the butyl rubber process can increase capacity by reducing fouling and other issues with the initiator system.

There remains a need for reducing variability of catalyst activity in a polymerization process to improve efficiency of a carbocationic polymerization process, especially in processes to produce unsaturated isoolefin copolymers such as butyl rubber.

### SUMMARY

A process for producing an unsaturated isoolefin copolymer comprises: sonicating a solution of an initiator system in an organic solvent, the initiator system comprising a Lewis acid catalyst and a proton source, to produce a sonicated initiator solution, the sonicating performed at an energy input of 100 J/mL or greater, based on volume of the initiator solution; and then, contacting the sonicated initiator solution with a reaction mixture of at least one isoolefin monomer and at least one copolymerizable unsaturated monomer in an organic diluent to produce the unsaturated isoolefin copolymer.

Sonication of the initiator solution improves catalyst activity, thereby improving conversion of the monomers during production of the unsaturated isoolefin copolymer. Variability of the catalyst activity is reduced, thereby increasing overall polymerization reactor capacity, reducing reactor fouling and reducing other issues with the initiator system.

A major benefit of sonication is to shorten the overall reactor length (residence time) required to achieve a target monomer conversion value (e.g., 82-85 mol %), meaning either that increased flow rates can be achieved through the existing continuous reactors or improved process control can be achieved by ensuring that a consistently high level of monomer conversion near the target value is achieved. In practice, reactors are operated at the highest possible flow rate that can be pushed through the reactor to achieve the target monomer conversion, so having a more active initiator system ensures that the target conversion value is reached and substantially all reactants in the feed mixture have reacted.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 is a graph of sonication energy input (J/mL) vs. isobutene (IB) conversion (mol %) showing the effect of sonication energy input on an initiator system in the copolymerization of isobutene with isoprene to produce butyl rubber.

FIG. 2A is a graph of polymerization reaction time (min:sec) vs. isobutene (IB) conversion (mol %) showing the effect of sonication time at 1 minute and 5 minutes with 1 mL of an initiator system in the copolymerization of isobutene with isoprene to produce butyl rubber.

FIG. 2B is a graph of polymerization reaction time (min:sec) vs. isobutene (IB) conversion (mol %) showing the effect of sonication time from 5 minutes to 20 minutes with 1.5 mL of an initiator system in the copolymerization of isobutene with isoprene to produce butyl rubber.

FIG. 3A is a graph of polymerization reaction time (min:sec) vs. isobutene (IB) conversion (mol %) showing the effect of the volume of an initiator solution on isobutene (IB) conversion comparing sonicated initiator solutions to unsonicated initiator solutions.

FIG. 3B is a graph of polymerization reaction time (min:sec) vs. isobutene (IB) conversion (mol %) showing the effect of the volume of a sonicated initiator solution on isobutene (IB) conversion, where the initiator solution has a higher concentration of catalyst than the initiator solutions of FIG. 3A.

FIG. 4A and FIG. 4B are graphs of polymerization reaction time (min:sec) vs. isobutene (IB) conversion (mol %) showing the effect of more water in the initiator solution (FIG. 4A) compared to less water in the initiator solution (FIG. 4B).

FIG. 5 is a graph of polymerization reaction time (min:sec) vs. isobutene (IB) conversion (mol %) showing the effect of isoprene (IP) loading in the reaction mixture on isobutene (IB) conversion comparing sonicated initiator solutions to unsonicated initiator solutions.

FIG. 6 is a graph of polymerization reaction time (min:sec) vs. isobutene (IB) conversion (mol %) showing the effect of increasing polymerization reaction time on isobutene (IB) conversion comparing sonicated initiator solutions to unsonicated initiator solutions.

FIG. 7 is a graph of polymerization reaction time (min:sec) vs. isobutene (IB) conversion (mol %) showing the effect of catalyst aging on isobutene (IB) conversion comparing sonicated initiator solutions to unsonicated initiator solutions.

### DETAILED DESCRIPTION

Production of the unsaturated isoolefin copolymer involves polymerizing at least one isoolefin monomer and at least one copolymerizable unsaturated monomer in an organic diluent in the presence of an initiator system (a Lewis acid catalyst and a proton source) capable of initiating the polymerization process. Polymerization occurs in a polymerization reactor. Suitable polymerization reactors include, for example, flow-through polymerization reactors, plug flow reactor, moving belt or drum reactors, and the like. The process may be a continuous or batch process. In a preferred embodiment, the process is a continuous polymerization process. The process may comprise slurry or solution polymerization of the monomers. In a preferred embodiment, the process is a slurry polymerization process.

The unsaturated isoolefin copolymer comprises repeating units derived from at least one isoolefin monomer and repeating units derived from at least one copolymerizable unsaturated monomer, and optionally repeating units derived from one or more further copolymerizable monomers. The unsaturated isoolefin copolymer preferably comprises an unsaturated isoolefin copolymer.

Suitable isoolefin monomers include hydrocarbon monomers having 4 to 16 carbon atoms. In one embodiment, the isoolefin monomers have from 4 to 7 carbon atoms. Examples of suitable isoolefins include isobutene (isobutylene), 2-methyl-1-butene, 3-methyl-1-butene, 2-methyl-2-butene, 4-methyl-1-pentene, 4-methyl-1-pentene and mixtures thereof. A preferred isoolefin monomer is isobutene (isobutylene).

Suitable copolymerizable unsaturated monomers include multiolefins, p-methyl styrene, β-pinene or mixtures thereof. Multiolefin monomers include hydrocarbon monomers having 4 to 14 carbon atoms. In some embodiments, the multiolefin monomers are conjugated dienes. Examples of suitable conjugated diene monomers include isoprene, butadiene, 2-methylbutadiene, 2,4-dimethylbutadiene, piperylene, 3-methyl-1,3-pentadiene, 2,4-hexadiene, 2-neopentylbutadiene, 2-methyl-1,5-hexadiene, 2,5-dimethyl-2,4-hexadiene, 2-methyl-1,4-pentadiene, 4-butyl-1,3-pentadiene, 2,3-dimethyl-1,3-pentadiene, 2,3-dibutyl-1,3-pentadiene, 2-ethyl-1,3-pentadiene, 2-ethyl-1,3-butadiene, 2-methyl-1,6-heptadiene, cyclopentadiene, methylcyclopentadiene, cyclohexadiene, 1-vinyl-cyclohexadiene and mixtures thereof. A preferred copolymerizable unsaturated monomer is isoprene.

The unsaturated isoolefin copolymer may optionally include one or more additional copolymerizable monomers. Suitable additional copolymerizable monomers include, for example, styrenic monomers, such as alkyl-substituted vinyl aromatic co-monomers, including but not limited to a C₁-C₄ alkyl substituted styrene. Specific examples of additional copolymerizable monomers include, for example, α-methyl styrene, p-methyl styrene, chlorostyrene, cyclopentadiene and methylcyclopentadiene. Indene and other styrene derivatives may also be used. In one embodiment, the halogenatable isoolefin copolymer may comprise random copolymers of isobutene, isoprene and p-methyl styrene.

The unsaturated isoolefin copolymer is formed by copolymerization of a monomer mixture. Preferably, the monomer mixture comprises about 80-99.9 mol % of at least one isoolefin monomer and about 0.1-20 mol % of at least one copolymerizable unsaturated monomer, based on the monomers in the monomer mixture. More preferably, the monomer mixture comprises about 90-99.9 mol % of at least one isoolefin monomer and about 0.1-10 mol % of at least one copolymerizable unsaturated monomer. In one embodiment, the monomer mixture comprises about 92.5-97.5 mol % of at least one isoolefin monomer and about 2.5-7.5 mol % of at least one copolymerizable unsaturated monomer. In another embodiment, the monomer mixture comprises about 97.4-95 mol % of at least one isoolefin monomer and about 2.6-5 mol % of at least one copolymerizable unsaturated monomer.

If the monomer mixture comprises the additional copolymerizable monomer with the isoolefins and/or copolymerizable unsaturated monomers, the additional copolymerizable monomer preferably replaces a portion of the copolymerizable unsaturated monomer. When a multiolefin monomer is used, the monomer mixture may also comprise from 0.01% to 1% by weight of at least one multiolefin cross-linking agent, and when the multiolefin cross-linking agent is present, the amount of multiolefin monomer is reduced correspondingly.

Suitable organic diluents may include, for example, alkanes, chloroalkanes, cycloalkanes, aromatics, hydrofluorocarbons (HFC) or any mixture thereof. Chloroalkanes may include, for example methyl chloride, dichloromethane or any mixture thereof. Methyl chloride is particularly preferred. Alkanes and cycloalkanes may include, for example, isopentane, cyclopentane, 2,2-dimethylbutane, 2,3-dimethylbutane, 2-methylpentane, 3-methylpentane, n-hexane, methylcyclopentane, 2,2-dimethylpentane or any mixture thereof. Alkanes and cycloalkanes are preferably C6 solvents, which include n-hexane or hexane isomers, such as 2-methyl pentane or 3-methyl pentane, or mixtures of n-hexane and such isomers as well as cyclohexane. The monomers are generally polymerized cationically in the diluent at temperatures in a range of from −120° C. to +20° C., preferably −100° C. to −50° C., more preferably −95° C. to −65° C. The temperature is preferably about −80° C. or colder.

The initiator system comprises a Lewis acid catalyst and a proton source. The catalyst preferably comprises aluminum trichloride (AlCl₃). Alkyl aluminum halide catalysts are also useful for catalyzing the polymerization reaction. Examples of alkyl aluminum halide catalysts include methyl aluminum dibromide, methyl aluminum dichloride, ethyl aluminum dibromide, ethyl aluminum dichloride, butyl aluminum dibromide, butyl aluminum dichloride, dimethyl aluminum bromide, dimethyl aluminum chloride, diethyl aluminum bromide, diethyl aluminum chloride, dibutyl aluminum bromide, dibutyl aluminum chloride, methyl aluminum sesquibromide, methyl aluminum sesquichloride, ethyl aluminum sesquibromide, ethyl aluminum sesquichloride and any mixture thereof. Preferred of alkyl aluminum halide catalysts are diethyl aluminum chloride (Et₂AlCl or DEAC), ethyl aluminum sesquichloride (Et_{1.5}AlCl_{1.5} or EASC), ethyl aluminum dichloride (EtAlCl₂ or EADC), diethyl aluminum bromide (Et₂AlBr or DEAB), ethyl aluminum sesquibromide (Et_{1.5}AlBr_{1.5} or EASB) and ethyl aluminum dibromide (EtAlBr₂ or EADB) and any mixture thereof. A particularly preferred alkyl aluminum halide catalyst comprises ethyl aluminum sesquichloride, preferably generated by mixing equimolar amounts of diethyl aluminum chloride and ethyl aluminum dichloride, preferably in a diluent. The diluent is preferably the same one used to perform the copolymerization reaction.

The proton source includes any compound that will produce a proton when added to the catalyst or a composition containing the catalyst. Protons are generated from the reaction of the catalyst with proton sources to produce the proton and a corresponding by-product. Proton sources include, for example, water (H₂O), alcohols, phenols, thiols, carboxylic acids, and the like or any mixture thereof. Water, alcohol, phenol or any mixture thereof is preferred. The most preferred proton source is water. A preferred ratio of catalyst to proton source is from 5:1 to 100:1 by weight, or from 5:1 to 50:1 by weight. The initiator system is preferably present in the reaction mixture in an amount providing 0.0007-0.02 wt % of the catalyst, more preferably 0.001-0.008 wt % of the catalyst, based on total weight of the reaction mixture.

The initiator system is dissolved in an organic solvent to produce an initiator solution, which is then contacted with the reaction mixture to initiate polymerization of the monomers. The organic solvent may comprise any of the organic diluents described above. Preferably, the organic solvent comprises a polar organic solvent. Methyl chloride is particularly preferred. The catalyst is preferably present in the initiator solution at a concentration of 0.01 wt % to 0.6 wt %, based on total weight of the initiator solution, more preferably 0.05 wt % to 0.6 wt %, 0.075 wt % to 0.5 wt % or 0.1 wt % to 0.4 wt %. The initiator system is preferably soluble in the reaction mixture.

To improve conversion of monomers to polymer thereby increasing efficiency of the polymerization reaction, the initiator solution is sonicated prior to contacting the initiator solution with the reaction mixture. Sonication of the initiator solution improves catalyst activity thereby improving conversion of the at least one isoolefin monomer, the at least one copolymerizable unsaturated monomer or both during production of the unsaturated isoolefin copolymer. In particular, improved conversions are achieved when energy input from sonication is 100 J/mL or greater, based on volume of the initiator solution, preferably 200 J/mL or greater, or 300 J/mL or greater, or 400 J/mL or greater, or 500 J/mL or greater. Preferably, the energy input from sonication is in a range of 100 J/mL to 1500 J/mL, or 200 J/mL to 1200 J/mL, 300 J/mL to 1000 J/mL, 400 J/mL to 900 J/mL, or 500 J/mL to 800 J/mL. Sonication is performed for a sufficient amount of time to improve catalyst activity. Preferably, the initiator solution is sonicated for 0.5 minutes or more, or 1 minute or more, or 0.5-30 minutes, or 1-30 minutes, or 1-20 minutes, or 1-10 minutes, or 0.5-10 minutes, or 0.5-20 minutes.

Sonication has been found to have no deleterious effects on the initiator system, and no negative impact on the molecular weight of the unsaturated isoolefin copolymer at various contents of the at least one copolymerizable unsaturated monomer. Sonication further permits dissolving the catalyst in the organic solvent at higher concentrations than is possible using standard stirring techniques. Sonication further permits dissolving the catalyst in the organic solvent at lower temperatures (e.g. −80° C. or colder) than is possible using standard stirring techniques.

Sonication of the initiator solution can improve conversion of the monomers in the polymerization reaction by at least 2× in comparison to a polymerization reaction where the initiator solution was not sonicated. In some embodiments, conversion of the monomers is improved to 20 mol % or greater, or even 40 mol % or greater, for example as high as 80 mol %. Monomer conversions can therefore be improved by up to 16× times or more in comparison to monomer conversions achieved without sonication of the initiator solution. In addition, sonication does not impact observed molecular weights of the unsaturated isoolefin copolymers produced in the polymerization reaction. The sonicated initiator solution is preferably contacted with the reaction mixture as soon as possible after sonication.

Sonication applies sound energy to agitate particles. Because ultrasonic frequencies (≥20 kHz) are usually used, sonication is also known as ultrasonication or ultra-sonication. Sonicators are generally well known and any suitably powerful sonicator may be used to sonicate the initiator solution. The power of the sonicator and the amplitude of sound waves generated by the sonicator can be suitably selected to provide energy input in the ranges described above and a sonication time that is suitably short while obtaining the desired monomer conversion. If lower amplitude is desires, a longer sonication time may be used, while sonication time may be reduced by using higher amplitudes of the sound waves.

Sonication can be used in conjunction with other methods of improving the performance of the initiator system. For example, the additional use of a tertiary ether (e.g., methyl t-butyl ether (MTBE), ethyl t-butyl ether (ETBE), methyl t-amyl ether (MTAE) and phenyl t-butyl ether (PTBE) or mixtures thereof, especially MTBE) in the initiator solution can have at least an additive effect with sonication in improving polymerization reaction efficiency. The use of tertiary ethers for improving initiator systems is described in International Patent Publication WO 2020/124212 published Jun. 25, 2020, the entire contents of which is herein incorporated by reference.

After the polymerization is complete, the unsaturated isoolefin copolymer may be recovered from the reaction mixture by known methods. For example, the organic diluent, organic solvent and residual monomers may be separated from the unsaturated isoolefin copolymer by flash separation using a heated organic solvent or steam. The unsaturated isoolefin copolymer may then be dried and processed into cements, crumbs, bales or the like for further use, storage or shipping.

### EXAMPLES

### Initiator Solution Preparation

0.3 g of AlCl₃ (99.99% purity) was added to 100 mL of liquid MeCl at −30° C. in a 125 mL Erlenmeyer flask, all inside an MBraun™ glovebox filled with nitrogen and equipped with liquid nitrogen cooled pentane baths. The mixture was stirred at approximately 300 rpm using an overhead stirrer for 45 minutes. The solution was then cooled to −95° C. and transferred to a 250 mL round bottom with a 45/50 joint. The solution contained a small amount of water as a proton source, the water being present as an impurity in the MeCl in an amount of about 15-50 ppmv.

To prepare sonicated initiator solutions, the initiator solution as prepared as described above was sonicated using a horn sonicator (QSonica™, 500 Watts, 20 KHz) for a desired period of time (within a period of 1-30 minutes) and at a desired amplitude level (50% of full horn movement for most experiments) to produce the sonicated initiator solution.

### Polymerization Reaction

Unsonicated and sonicated initiator solutions were then used to prepare butyl rubber (isobutene-co-isoprene) by adding the sonicated initiator solution to a mixture of isobutene and isoprene in methyl chloride as follows.

Methyl chloride (MeCl) and isobutene (IB) at −96° C. and isoprene (IP) at room temperature were added to a reactor that was cooled to −96° C. The reaction mixture was then cooled to about −91° C. with stirring at 800 rpm. Then, a desired volume of the initiator solution was added in a manner to provide good initiation without a high temperature increase of the reaction mixture.

During polymerization, the reaction was monitored using an immersion Raman spectrometer to measure conversion of isobutene.

The polymerization reaction was then quenched after 5 minutes by adding to the reaction mixture 1 mL of a solution of 1 wt % NaOH in ethanol. The reaction was terminated if the temperature of the reaction mixture increased by more than 20° C. before the end of 5 minutes. The reactor was then removed from the glovebox and 1 mL of dilute antioxidant solution (1 wt % Irganox™ 1076 in hexanes) was added, along with further hexanes to dilute the reaction mixture. The methyl chloride was allowed to evaporate overnight to form a butyl rubber cement in hexanes. The butyl rubber was then coagulated from the hexane cement using ethanol and dried overnight at 60° C. under vacuum.

¹H NMR was used to determine isoprene content of the butyl rubber that was formed and GPC analysis was used to determine molecular weight of the butyl rubber that was formed.

### Example 1: Effect of Sonication Energy Input on Monomer Conversion

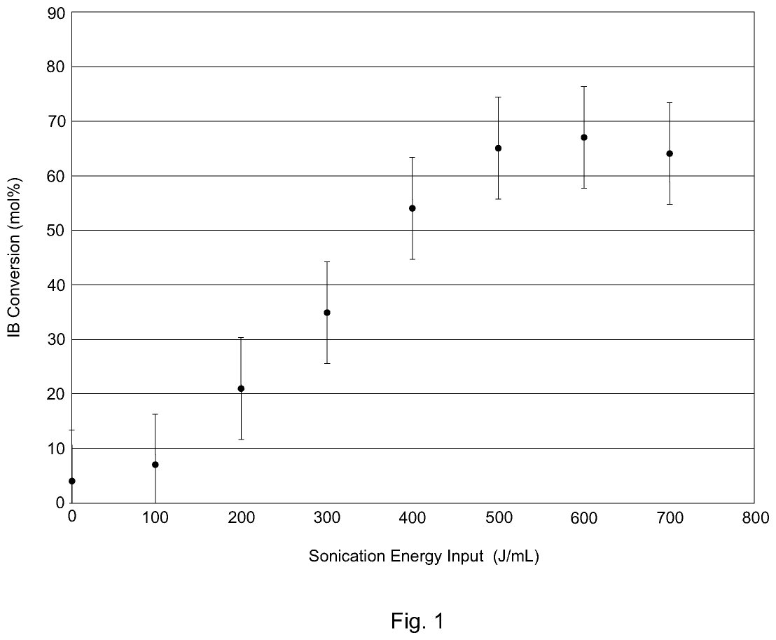

Polymerization reactions to produce butyl rubber were conducted as described above using initiator solutions that were sonicated to achieve sonication energy inputs ranging from 100-700 J/mL in increments of 100 J/mL and compared to a polymerization reaction where the initiator solution was not sonicated (i.e., 0 J/mL). Sonication energy input was normalized to Joules per mL of initiator solution to provide an indication of whether sonication energy affects monomer conversion. FIG. 1 shows the results.

FIG. 1 shows that isobutene (IB) conversion was about 4 mol % for the unsonicated sample (0 J/mL) using 1 mL of initiator solution for polymerization with the IB conversion increasing to about 8 mol % when the initiator solution is sonicated with an energy input of 100 J/mL, and thereafter increasing until the IB conversion plateaued at about 68 mol % at a sonication energy input of about 600 J/mL. Sonication can therefore improve monomer conversion by about 2-17× depending on the sonication energy input, and can improve monomer conversion to close to 70 mol %.

### Example 2: Effect of Sonication Time on Monomer Conversion

Polymerization reactions to produce butyl rubber were conducted as described above using initiator solutions that were not sonicated or were sonicated at the same sonication energy input for different lengths of time.

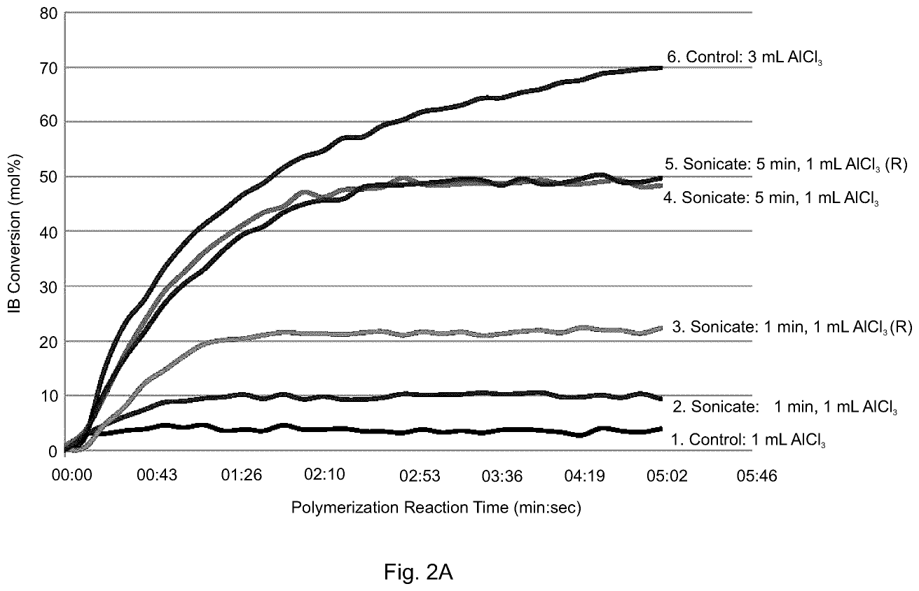

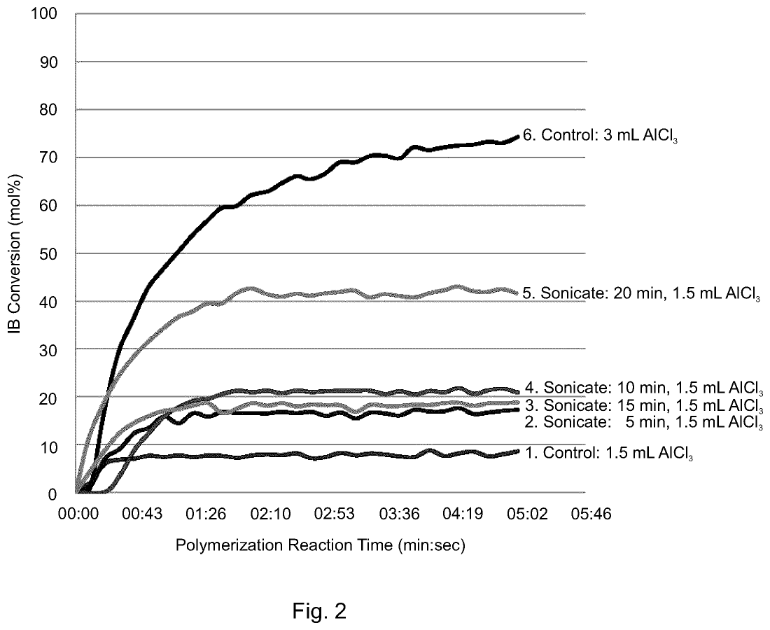

FIG. 2A shows the effect on isobutene (IB) conversion of sonication times at 1 minute and 5 minutes with 1 mL of an aluminum trichloride initiator system in which the initiator solution was dried with a drying tube to lower the water content. The results were compared to isobutene (IB) conversion resulting from Control polymerization reactions in which 1 mL and 3 mL of unsonicated initiator solution were used. The 1 mL Control provided an IB conversion of about 4 mol %, whereas 1 mL of the initiator solution sonicated for 1 min provided an IB conversion of about 10-20 mol %. Sonication for 5 min resulted in an IB conversion of about 48-50 mol %. Thus, sonicating the initiator solution improves IB conversion and allows for the use of less initiator solution.

FIG. 2B is shows the effect on isobutene (IB) conversion of sonication times from 5 minutes to 20 minutes with 1.5 mL of an aluminum trichloride initiator system. The results were compared to isobutene (IB) conversion resulting from Control polymerization reactions in which 1.5 mL and 3 mL of unsonicated initiator solution were used. The 1.5 mL Control provided an IB conversion of about 8 mol %, whereas sonication of 1.5 mL of the initiator solution for 5 min increased IB conversion to about 17 mol %. Sonication for 10 min or 15 min increased IB conversion to about 20 mol %, while sonication for 20 min increased IB conversion to about 42 mol %.

### Example 3: Effect of Volume of the Initiator Solution on Monomer Conversion

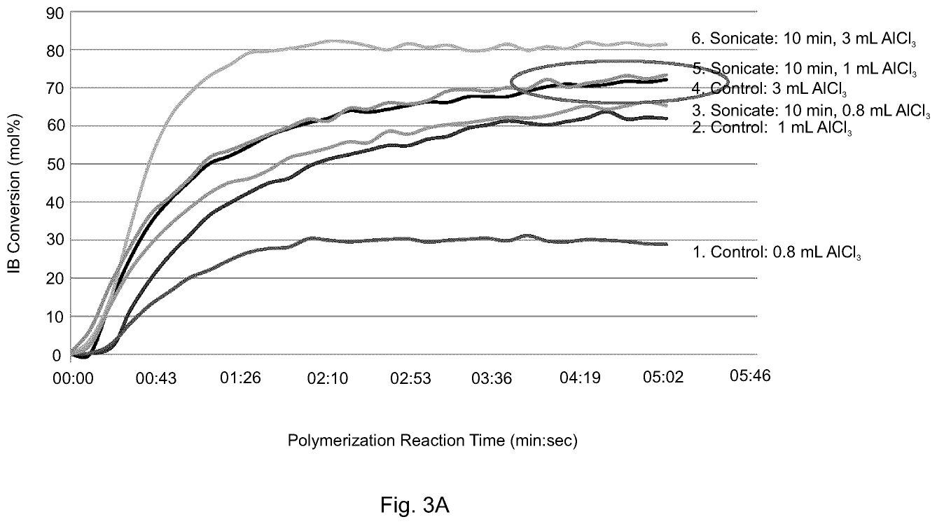

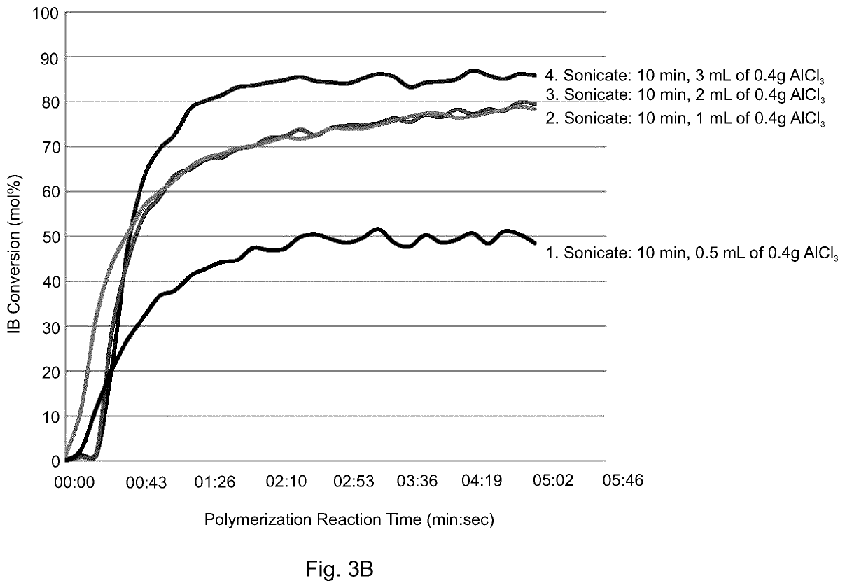

Polymerization reactions to produce butyl rubber were conducted as described above using different volumes (0.8 mL, 1 mL and 3 mL) of aluminum trichloride initiator solutions that were not sonicated or were sonicated at the same sonication energy input for the same length of time, i.e., 10 minutes. FIG. 3A shows the effect of the volume of an initiator solution on isobutene (IB) conversion comparing sonicated initiator solutions to unsonicated initiator solutions. As seen in FIG. 3A, IB conversion using the sonicated initiator solution was always better than when using the corresponding Control in which the initiator solution was not sonicated. Further, increasing the volume from 0.8 mL to 3 mL increased IB conversion for both sonicated and unsonicated initiator solutions. It was possible to increase IB conversion to over 80 mol % by using 3 mL of the initiator solution that was sonicated for 10 minutes, whereas the IB conversion was only about 72 mol % when using the unsonicated Control using 3 mL of the initiator solution, which was about the same as using only 1 mL of the sonicated initiator solution.

When the amount of aluminum trichloride dissolved in 100 mL methyl chloride was increased to 0.4 g to prepare the initiator solution, IB conversions were increased even more as illustrated in FIG. 3B. Using only 0.5 mL of such an initiator solution along with sonication provided an IB conversion of about 50 mol %. When 3 mL of the sonicated initiator solution was used, the IB conversion was increased to about 85 mol %.

### Example 4: Effect of Water Content of the Initiator Solution on Monomer Conversion

Polymerization reactions to produce butyl rubber were conducted as described above using aluminum trichloride initiator solutions that were not sonicated or were sonicated at the same sonication energy input for different lengths of time. In one set of experiments, the initiator solution was used without drying, and in a second set of experiments the initiator solutions were further dried with a drying tube to lower water content in the diluent. The water content was not brought to zero since protons are necessary for the initiator system. The water content in the MeCl was about 45-50 ppmv before drying, and about 15-25 ppmv after drying.

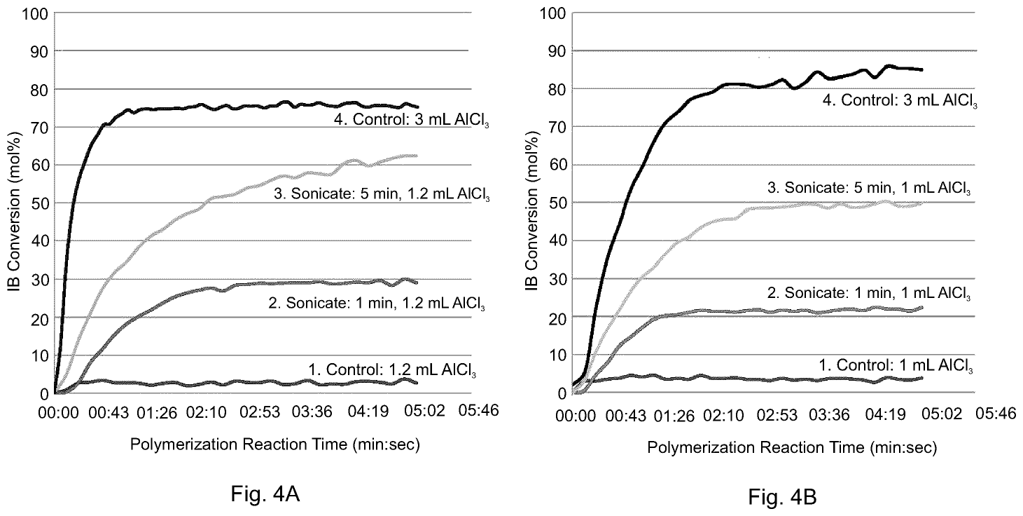

Comparing FIG. 4A (no drying) to FIG. 4B (drying), it can be seen that IB conversion is relatively unaffected by water content of the initiator (provided sufficient protons are available for initiating the polymerization).

### Example 5: Effect of Isoprene Loading in the Reaction Mixture on Monomer Conversion

Polymerization reactions to produce butyl rubber were conducted as described above using 1 mL of aluminum trichloride initiator solutions that were not sonicated or were sonicated at the same sonication energy input for the same length of time. However, the amount of isoprene (IP) monomer used in the polymerization reaction was varied (0.5 mL IP, 0.7 mL IP and 1 mL IP) to determine the effect of sonicating the initiator solution on isoprene content and molecular weight of the butyl rubber produced in the polymerization.

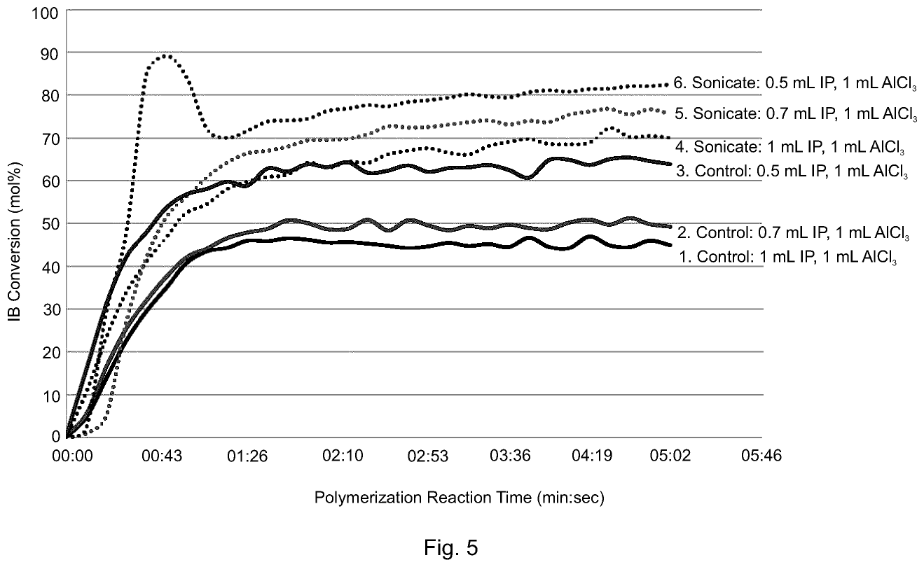

FIG. 5 shows that over the entire range of isoprene loading explored, IB conversion is increased when using a sonicated initiator solution when compared to the unsonicated counterpart. Further, sonication appears to reduce variability of IB conversion across the range of isoprene loading.

Table 1 shows that over the entire range of isoprene loading explored, sonication of the 1 mL initiator solution did not unduly affect either the weight average molecular weight (MW) or isoprene content (Total Unsats) of the butyl rubber polymer that was produced.

TABLE 1

| | IP Loading | M_{w} | Total Unsats | IB Conversion |
|---|---|---|---|---|
| Sonication | (mL) | (g/mol) | (mol %) | (mol %) |
| No | 1 | 776,406 | 1.96 | 45 |
| Yes | 1 | 703,026 | 2.35 | 70 |
| No | 0.7 | 910,152 | 1.47 | 49 |
| Yes | 0.7 | 887,686 | 1.62 | 76 |
| No | 0.5 | 1,035,926 | 1.13 | 64 |
| Yes | 0.5 | 1,000,102 | 1.24 | 82 |

### Example 6: Effect of Increasing Polymerization Reaction Time on Monomer Conversion

Polymerization reactions to produce butyl rubber were conducted as described above using 0.6 mL of aluminum trichloride initiator solutions that were not sonicated or were sonicated at the same sonication energy input (i.e., 20% of full power instead of 50%) for the same length of time (i.e., 30 min). One of the reactions was allowed to run for 10 minutes instead of 5 minutes before quenching.

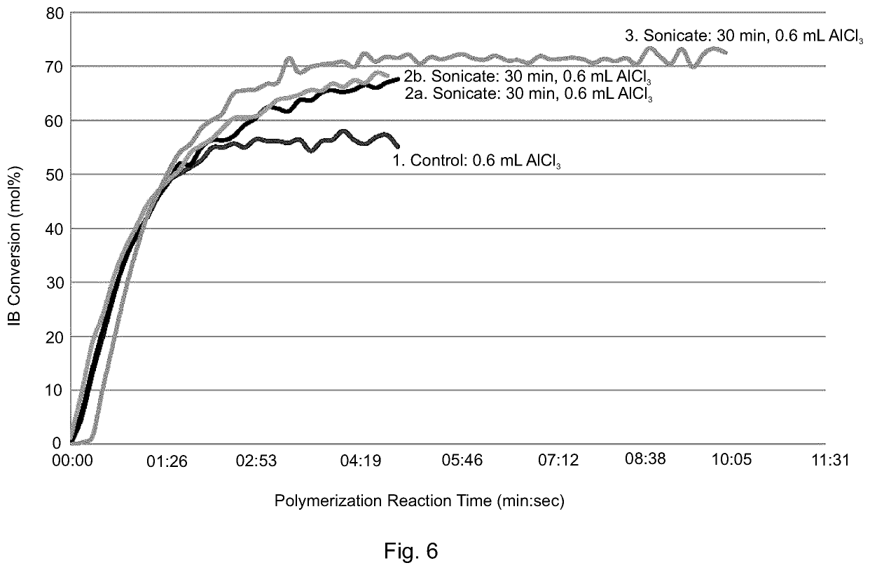

FIG. 6 shows the effect of increasing polymerization reaction time on isobutene (IB) conversion. IB conversion increased to about 73 mol % for the 10-min reaction instead of about 67 mol % for the 5-min reactions.

### Example 7: Effect of Initiator Aging on Monomer Conversion

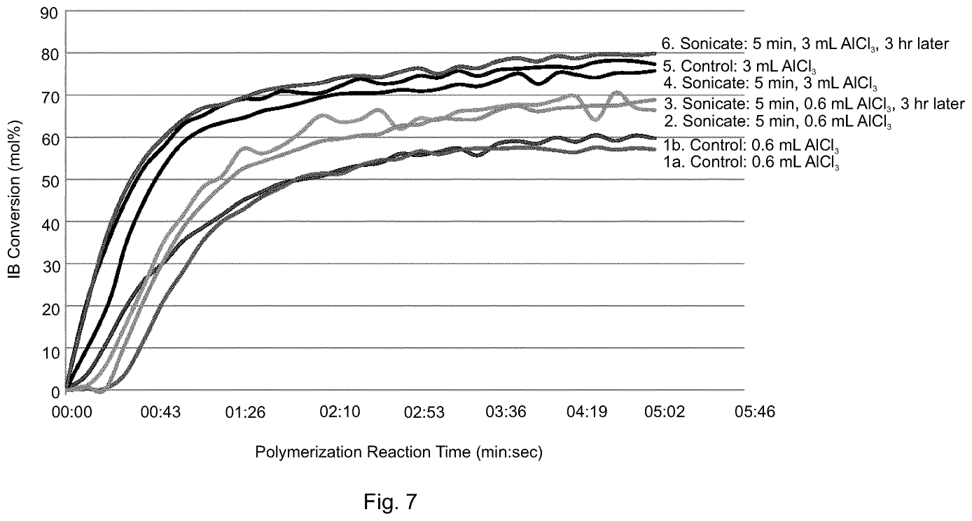

Polymerization reactions to produce butyl rubber were conducted as described above using different volumes (i.e., 0.6 mL and 3 mL) of aluminum trichloride initiator solutions that were not sonicated or were sonicated at the same sonication energy input for the same length of time (i.e., 5 min). The initiator solutions were used immediately in the polymerization reactions except for one of the 0.6 mL samples of sonicated initiator solution and one of the 3 mL samples of sonicated initiator solution, which were allowed to age for 3 hours prior to use in the polymerization reaction. FIG. 7 shows the effect of catalyst aging on isobutene (IB) conversion. As seen in FIG. 7, aging the catalyst for 3 hours had relatively no effect on IB conversion.

### Example 8: Effect of Sonication in the Polymerization of Isobutene with p-Methylstyrene

A copolymer (IMS) of isobutene (IB) and p-methylstyrene (PMS) was prepared in a manner similar to the preparation of the butyl rubber copolymer described above. While the same volume of methyl chloride was used, half the volume of isobutene used in the butyl polymerizations and 1/10^{th} of this volume of p-methylstyrene were added to the cooled reactor. No isoprene was added to these polymerizations.

Using 1.5 mL, 2 mL and 2.5 mL of the initiator, the effect of sonication energy input on yield of the copolymer was determined at sonication energy inputs of 0 J/mL and 230 J/mL. The results are shown in Table 2. It is apparent from Table 2 that sonication of the initiator improves the yield of IMS, particularly at lower amounts of the initiator.

TABLE 2

| Amount | Sonication | | |
|---|---|---|---|
| Initiator (mL) | Energy (J/mL) | Yield of IMS (g) | % Yield |
| 1.5 | 0 | 0.406 | 5.11 |
| 1.5 | 230 | 1.429 | 18.0 |
| 2 | 0 | 1.682 | 21.2 |
| 2 | 230 | 1.896 | 23.9 |
| 2.5 | 0 | 5.978 | 75.2 |
| 2.5 | 230 | 6.189 | 77.9 |

The novel features will become apparent to those of skill in the art upon examination of the description. It should be understood, however, that the scope of the claims should not be limited by the embodiments, but should be given the broadest interpretation consistent with the wording of the claims and the specification as a whole.

What is claimed is:

1. A process for producing an unsaturated isoolefin copolymer, the process comprising:
sonicating a solution of an initiator system in an organic solvent, the initiator system comprising a Lewis acid catalyst and a proton source, to produce a sonicated initiator solution, the sonicating performed at an energy input of 100 J/mL or greater, based on volume of the initiator solution; and then,
contacting the sonicated initiator solution with a reaction mixture of at least one isoolefin monomer and at least one copolymerizable unsaturated monomer in an organic diluent to produce the unsaturated isoolefin copolymer.

2. The process of claim 1, wherein the energy input is in a range of 100 J/mL to 1500 J/mL.

3. The process of claim 4, wherein the energy input is in a range of 500 J/mL to 800 J/mL.

4. The process of claim 1, wherein in sonication is performed for 0.5 minutes or more.

5. The process of claim 3, wherein in sonication is performed for 1-10 minutes.

6. The process of claim 1, wherein the organic solvent comprises methyl chloride.

7. The process of claim 1, wherein the Lewis acid catalyst is present in the initiator solution at a concentration of 0.01 wt % to 0.6 wt %, based on total weight of the initiator solution.

8. The process of claim 1, wherein the initiator system is present in the reaction mixture in an amount of 0.0007 wt % to 0.02 wt %, based on total weight of the reaction mixture.

9. The process of claim 1, to wherein the Lewis acid catalyst and the proton source are present in the initiator system in a ratio of from 5:1 to 50:1 by weight.

10. The process of claim 1, wherein the Lewis acid catalyst comprises aluminum trichloride.

11. The process of claim 1, wherein the proton source comprises water.

12. The process of claim 1, wherein the initiator system is soluble in the reaction mixture.

13. The process of claim 1, wherein the organic diluent comprises methyl chloride.

14. The process of claim 1, wherein the solution of the initiator system further comprises a tertiary ether.

15. The process of claim 13, wherein the solution of the initiator system further comprises methyl t-butyl ether.

16. The process of claim 1, wherein the at least one isoolefin monomer is isobutene and the at least one copolymerizable unsaturated monomer is isoprene.

17. The process of claim 1, wherein the at least one isoolefin monomer is isobutene and the at least one copolymerizable unsaturated monomer is p-methylstyrene.

18. The process of claim 16, wherein the reaction mixture comprises at least one additional copolymerizable monomer.

19. The process of claim 18, wherein the at least one copolymerizable monomer comprises α-methyl styrene, p-methyl styrene, chlorostyrene, cyclopentadiene, methylcyclopentadiene, indene or any mixture thereof.

20. The process of claim 1, wherein the process is a slurry process, the process is a continuous process or the process is both a slurry process and a continuous process.
